(19) United States
(12) Patent Application Publication
(10) Pub. No.: US 2002/0012348 A1
(43) Pub. Date: Jan. 31, 2002

(54) Router device and priority control method for use in the same

(75) Inventors: Bun Mizuhara, Tokyo (JP); Nana Takashima, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/912,598

(22) Filed: Jul. 26, 2001

(30) Foreign Application Priority Data
Jul. 26, 2000 (JP) 2000-224743

(51) Int. Cl. H04L 12/28; H04L 12/56

(52) U.S. Cl. 370/392; 370/400

(57) ABSTRACT

The present invention provides a router device capable of using separated queues with arbitrary fineness and flexibly achieving assurance and separation of traffic. Flow identifier 2 detects a flow of packets input to the device. Flow monitor 1 detects color information indicating match (Green) of actual traffic to a previously defined bandwidth under contract for each flow, temporal violation (Yellow), or complete violation (Red). Forwarding searcher 3 determines, from contents of a packet, output line information indicating from which line the packet is to be output. In-device packet controller 4 adds in-device cell header information to a packet input thereto, converts it into a form in the device (an in-device cell), and sends it to input side in-device cell buffer 5.

### BACKGROUND OF THE INVENTION

1. Field of the Invention

The present invention relates to a router device and a priority control method for use in the router device, and more particularly to a priority control method for use in packet transmission on a network.

2. Description of the Related Art

Conventional IP (Internet Protocol) networks are of a Best Effort type in which all packets are handled equally and all possible efforts are made to send the packets to their destinations but there is no assurance.

The networks have disadvantages; (1) an available bandwidth or a delay time, or even arrival of a packet is not ensured, (2) a packet including important contents and a packet including unimportant contents are handled totally equally, and (3) interference with other communications is readily caused, for example, by inserting a large amount of packets into a network.

The networks, however, are sufficient for use as networks for research which suppose unmalicious users and do not require reliability or realtime processing, and can realize simple and efficient networks. Thus, the networks have been developed rapidly.

As the IP networks are utilized for commercial use as well as for research, the need to provide services exceeding the Best Effort networks arises, for example, in order to handle important traffic separately from normal traffic. To that end, some assurances (specifically, a bandwidth, delay time or the like) are required first for packets in important traffic.

Separation of traffic is also needed to prevent important traffic from experiencing interference with other traffic or malicious disturbance. In addition, when a user attempts to use traffic over permitted traffic under contract, it is necessary to discard the packet of such a user as required with high priority to protect other traffic.

To satisfy these needs, the IETF (Internet Engineering Task Force) has discussed a service model called Integrated Services to control traffic for each application flow.

The model, however, performs traffic control significantly finely. Thus, it is pointed out that a huge load is placed on a router device and introduction on a large scale cannot possibly be made in practice. Recently, a model called Differentiated Services is mainly used in which packets are grouped into 64 classes at the maximum and priorities are assigned to the classes.

The assurance, separation, and protection of traffic are realized specifically by using separated queues for respective traffic within a router. The Differentiated Services attempt to realize the assurance, separation, and protection of traffic by using several queues depending on the number of classes and providing a difference in discard probability among them.

While the aforementioned conventional priority control method mainly employs the model for grouping packets into 64 classes at the maximum and assigning priorities to the classes, interference of traffic with other traffic which uses the same queue cannot be avoided.

The Differentiated Services are sufficient if traffic control is required only for each of services grouped into classes. To exactly assure important traffic or prevent mutual interference, however, it is necessary to use separated queues more finely.

### SUMMARY OF THE INVENTION

It is an object of the present invention to provide a router device and a priority control method for use in the router device capable of eliminating the aforementioned problems, using separated queues with arbitrary fineness, and flexibly providing assurance and separation of traffic.

The router device according to the present invention adds unique header information to a packet within the device in processing the packet, and comprises packet control means for adding the header information to the packet, the header information including at least an in-device priority mode for representing priority in the device, an in-device discard level for representing a probability of discard in the device, and a queue number for performing bandwidth control, wherein the header information is used to perform priority control.

The method of controlling priority according to the present invention is for a router device adding unique header information to a packet within the device in processing the packet, and comprises the steps of adding the header information to the packet, the header information including at least an in-device priority mode for representing priority in the device, an in-device discard level for representing a probability of discard in the device, and a queue number for performing bandwidth control, and using the header information to perform priority control.

The method of controlling priority according to the present invention is for a router device adding unique header information to a packet within the device in processing the packet. The header information includes information such as the in-device priority mode, in-device discard level, and queue number for performing bandwidth control. The information is used to allow priority control.

More specifically, the router device according to the present invention has a flow identifier for detecting a flow of packets (a set of packets having a certain property) input to the device, a flow rate monitor for detecting color information indicating match of actual traffic to a previously defined bandwidth under contract for each flow (Green), temporal violation (Yellow), or complete violation (Red), and a forwarding searcher for determining, from contents of a packet, output line information indicating from which line the packet is to be output.

The aforementioned output line information includes logical line information in addition to information on a physical line. An in-device packet controller converts an input packet into a form in the device (in-device cell) by adding in-device cell header information thereto, and sends it to an input side in-device cell buffer. The in-device cell header information includes the in-device priority mode, in-device discard level, queue number and the like added on the basis of the flow information detected by the flow identifier, the color information detected by the flow rate monitor, and the output line information determined by the forwarding searcher.

The in-device cell is once stored in the input side in-device cell buffer, and directed to a switch under control of an input-side bandwidth controller based on the in-device cell header information. The switch outputs the cell to an output side in-device cell buffer for a line to which the cell is to be output on the basis of the in-device cell header information, and the cell is once stored therein.

The stored cell is directed to the in-device packet controller under control of an output side bandwidth controller based on the in-device cell header information, assembled again as a packet, and then output to the output side line. At this point, the queue number can be used as the aforementioned logical line information.

While the aforementioned description is provided for the case of one line section for simplification, a plurality of line sections typically exist and an in-device cell is switched among them.

In this manner, the in-device cell header is added on the basis of each of the detection results in the flow monitor, flow identifier, and forwarding searcher, and the information is relied on to operate the input side bandwidth controller, switch, output side bandwidth controller and the like, thereby allowing realization of flexible priority control.

In other words, the in-switch priority and in-queue discard level are used to realize Differentiated Services, and at the same time, the value of the output queue number can be designated. It is thus possible to use separated queues with arbitrary fineness to enable flexible assurance and separation of traffic.

As described above, according to the present invention, in the router device adding the unique header information to a packet within the device in processing the packet, at least the in-device priority mode for representing priority in the device, the in-device discard level for representing a probability of discard in the device, and the queue number for performing bandwidth control are included in the header information and added to the packet, and the header information is used to perform priority control. Therefore, it is advantageously possible to use separated queues with arbitrary fineness and to flexibly achieve assurance and separation of traffic.

### BRIEF DESCRIPTION OF THE DRAWINGS

FIG. 1 is a block diagram showing a configuration of a router device according to an embodiment of the present invention;

FIG. 2 is a block diagram showing a configuration of a router device according to an example of the present invention;

FIG. 3 shows an exemplary configuration of a PPP packet for use in the example of the present invention;

FIG. 4 is a flow chart illustrating processing operations for outputting an in-switch priority mode by a flow identifier in FIG. 2;

FIG. 5 is a flow chart illustrating processing operations for outputting an in-queue discard level by the flow identifier in FIG. 2;

FIG. 6 shows an exemplary configuration of an in-device packet for use in the example of the present invention;

FIG. 7 shows an exemplary configuration of an in-device packet for use in the example of the present invention;

FIG. 8 illustrates processing operations at ports #0 to #15 of an input side bandwidth controller in FIG. 2;

FIG. 9 is a table for illustrating classification based on values of the in-switch priority mode in FIG. 2;

FIG. 10 is a table for illustrating discard priorities based on values of the in-queue discard level in FIG. 2;

FIG. 11 is a flow chart illustrating processing operations of the input side bandwidth controller in FIG. 2;

FIG. 12 illustrates processing operations of an output side in-device cell buffer in FIG. 2;

FIG. 13 is a table for illustrating determination of which queue is used on the basis of the value of the in-switch priority mode in FIG. 2.

FIG. 14 is a schematic diagram showing an exemplary configuration of an ATM cell for use in the example of the present invention;

FIG. 15 is a block diagram showing a configuration of a router device according to another example of the present invention; and

FIG. 16 is a schematic diagram showing a configuration of an MPLS packet for use in the other example of the present invention.

### DESCRIPTION OF THE PREFERRED EMBODIMENT

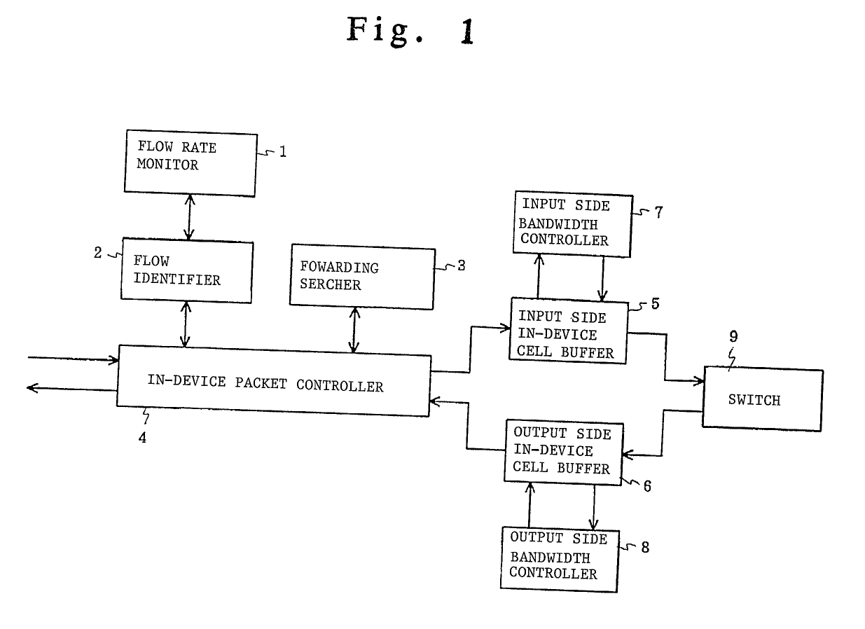

Next, an embodiment of the present invention is described with reference to the drawings. FIG. 1 is a block diagram showing a configuration of a router device according to the embodiment of the present invention. In FIG. 1, the router device according to the embodiment of the present invention comprises flow rate monitor 1, flow identifier 2, forwarding searcher 3, in-device packet controller 4, input side in-device cell buffer 5, output side in-device cell buffer 6, input side bandwidth controller 7, output side bandwidth controller 8, and switch 9.

Flow rate monitor 1 detects color information indicating match of actual traffic to a previously defined bandwidth under contract for each flow (Green), temporal violation (Yellow), or complete violation (Red). Flow identifier 2 detects a flow of packets (a set of packets having a certain property) input to the device. Forwarding searcher 3 determines, from the contents of a packet, output line information indicating from which line the packet is to be output. The output line information includes information on a logical line in addition to information on a physical line.

In-device packet controller 4 adds in-device cell header information to a packet input thereto for conversion into an in-device form (in-device cell), and sends it to input side in-device cell buffer 5. The in-device cell header information includes an in-device priority mode, an in-device discard level, a queue number and the like, added on the basis of the flow information detected by flow identifier 2, the color information detected by flow rate monitor 1, the output line information determined by forwarding searcher 3. The in-device priority mode represents a priority in the device, and the in-device discard level represents a probability of discard in the device.

The in-device cell is once stored in input side in-device cell buffer 5, and sent to switch 9 under control of input side bandwidth controller 7 based on the in-device cell header information. Switch 9 outputs the cell to output side in-device cell buffer 6 for a line to which the cell is to be output on the basis of the in-device cell header information, and the cell is once stored therein. The stored cell is sent to in-device packet controller 4 under control of output side bandwidth controller 8 based on the in-device cell header information, and assembled as a packet again, and then output to an output side line (not shown). The queue number can be used as the aforementioned logical line information.

While the embodiment of the present invention is described for the case of one line section for simplification, a plurality of line sections typically exist and an in-device cell is switched among them.

In this manner, in the embodiment of the present invention, the in-device cell header is added on the basis of each of the detection results in flow monitor 1, flow identifier 2, and forwarding searcher 3, and the information is relied on to operate input side bandwidth controller 7, switch 9, output side bandwidth controller 8 and the like, thereby allowing realization of flexible priority control.

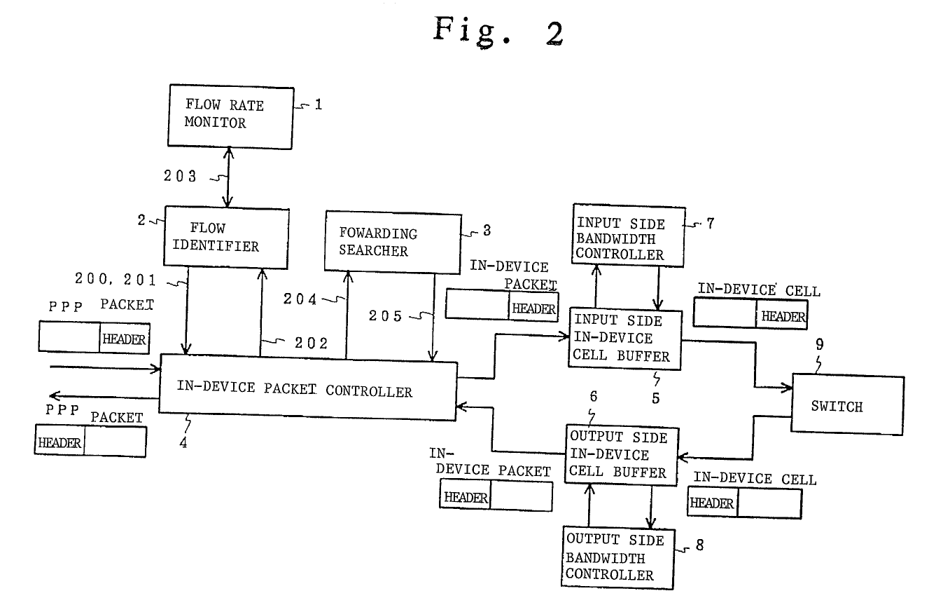

FIG. 2 is a block diagram showing a configuration of a router device according to one example of the present invention. FIG. 2 illustrates an exemplary configuration when flow detection is performed on the basis of a DA (Destination Address) of an IP (Internet Protocol) packet on a PPP (Point-to-Point Protocol). Since respective components are similar to those of the embodiment of the present invention shown in FIG. 1, the same reference numerals are used. Detailed description thereof is omitted since their functions are also similar to those in the embodiment of the present invention. In addition, how flow rate monitor 1 is realized is described, for example, in RFC (Request For Comments) 2698 and the like.

Flow rate monitor 1 and flow identifier 2 transmit and receive color information (Green/Yellow/Red) 203. In this case, color information 203 of Red indicates violation of an average rate of an input packet (PPP packet), color information 203 of Yellow indicates violation of a peak rate, and color information 203 of Green indicates no violation.

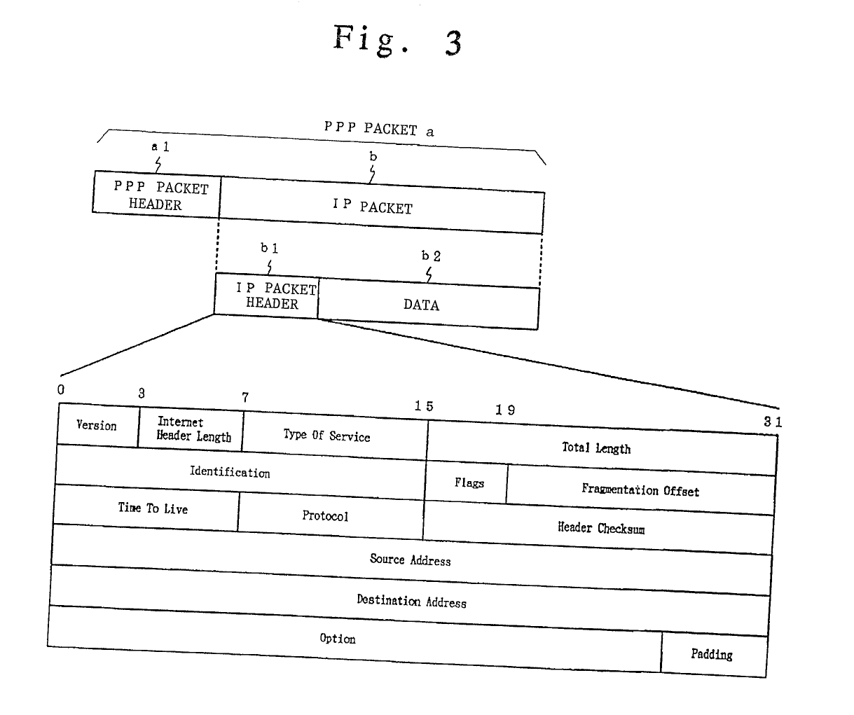

FIG. 3 shows an exemplary configuration of a PPP packet for use in the example of the present invention. In FIG. 3, PPP packet a includes PPP packet header al and IP packet b.

IP packet b includes IP packet header b1 and data b2. IP packet header b1 has Version, Internet Header Length, Type Of Service, Total Length, Identification, Flags, Fragmentation, Offset, Time To Live, Protocol, Header Checksum, Source Address, Destination Address, Option, and Padding, stored therein.

As shown in FIG. 3, in-device packet controller 4 removes PPP header al in PPP packet a input thereto, and if that is an IP packet, passes IP packet header b1 to flow identifier 2 and forwarding searcher 3.

FIG. 4 is a flow chart illustrating processing operations for outputting an in-switch priority mode by flow identifier 2 in FIG. 2. Description is made for the processing operations to output an in-switch priority mode by flow identifier 2 with reference to FIGS. 2 to 4.

Flow identifier 2 searches IP packet header b1 for a DA (step S1 in FIG. 4), and as a result of flow identification, outputs in-switch priority mode (4 bit) 200 to in-device packet controller 4. The flow identification may be performed by using another arbitrary field in IP packet header b1 or data b2.

If a match is found as a result of the flow identification step S2 in FIG. 4), and if color information 203 output from flow rate monitor (PLC) 1 represents Green (step S3 in FIG. 4), flow identifier 2 outputs the result of the flow identification as the value of in-switch priority mode 200 to in-device packet controller 4 (step S4 in FIG. 4).

If color information 203 output from flow rate monitor 1 represents Yellow or Red (step S3 in FIG. 4), flow identifier 2 outputs “0011” (which can be set by a register) as the value of in-switch priority mode 200 to in-device packet controller 4 (step S5 in FIG. 4).

If no match is found as a result of the flow identification (step S2 in FIG. 4), flow identifier 2 outputs a default value “0011” (which can be set by a register) as the value of in-switch priority mode 200 to in-device packet controller 4 (step S5 in FIG. 4).

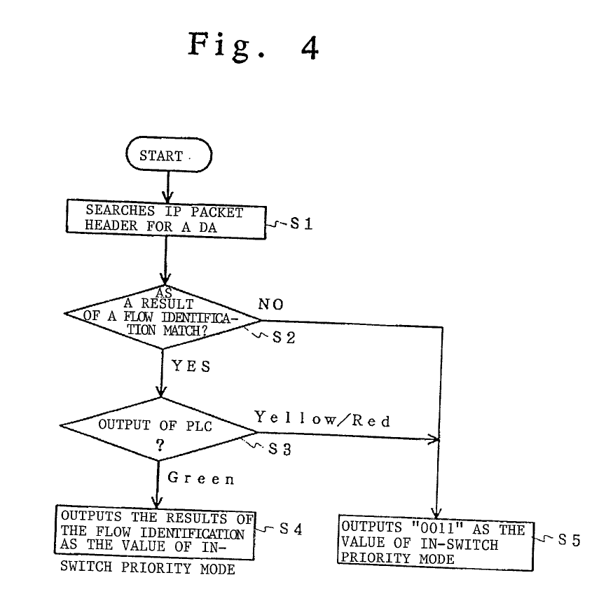

FIG. 5 is a flow chart illustrating processing operations for outputting an in-queue discard level by flow identifier 2. Description is made for the processing operations to output an in-queue discard level by flow identifier 2 with reference to FIGS. 2, 3, and 5.

Flow identifier 2 searches IP packet header b1 for a DA (step S11 in FIG. 5), and as a result of flow identification, outputs a value of in-queue discard level (4 bit) 201 to in-device packet controller 4.

If a match is found as a result of the flow identification (step S12 in FIG. 5), and if color information 203 output from flow rate monitor 1 represents Green (step S13 in FIG. 5), flow identifier 2 outputs the result of the flow identification as the value of in-queue discard level 201 to in-device packet controller 4 (step S15 in FIG. 5).

If color information 203 output from flow rate monitor 1 represents Yellow (step S13 in FIG. 5), flow identifier 2 outputs “0011” (which can be set by a register) as the value of in-queue discard level 201 to in-device packet controller 4 (step S16 in FIG. 5).

If color information 203 output flow rate monitor 1 represents Red (step S13 in FIG. 5), flow identifier 2 outputs “1111” (which can be set by a register) as the value of in-queue discard level 201 to in-device packet controller 4 (step S14 in FIG. 5).

If no match is found as a result of the flow identification (step S12 in FIG. 5), flow identifier 2 outputs a default value “0011” (which can be set by a register) as the value of in-queue discard level 201 to in-device packet controller 4 (step S16 in FIG. 5).

Forwarding searcher 3 outputs a value obtained as a result of a DA search in IP packet header b1 as output queue number (16 bits) 205 to in-device packet controller 4. Output queue number 205 can be used, as later described, as a logical line number of an output line (for example, a VPI/VCI (Virtual Path Identifier/Virtual Channel Identifier) for ATM (Asynchronous Transfer Mode)), or Next Hop information (for common medium line such as Ethernet).

It is extremely easy to extend priority control, later described, by using output queue number 205 to select a queue in output side in-device cell buffer 6, for example.

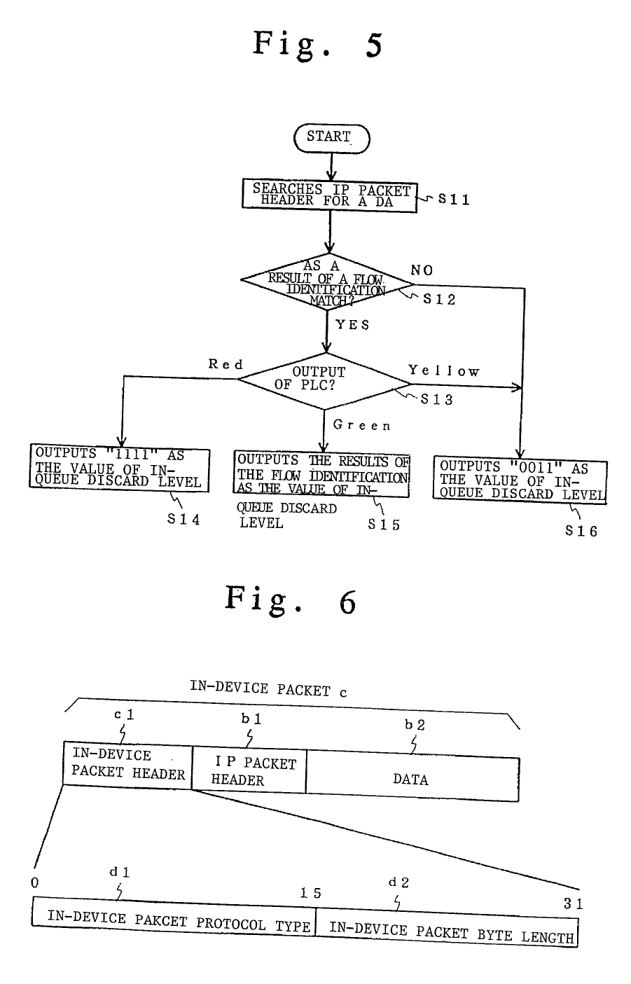

FIG. 6 shows an exemplary configuration of an in-device packet for use in the example of the present invention. In FIG. 6, in-device packet c includes in-device packet header c1, IP packet header b1, and data b2. In-device packet header c1 has in-device packet protocol type d1 and in-device packet byte length d2 stored therein.

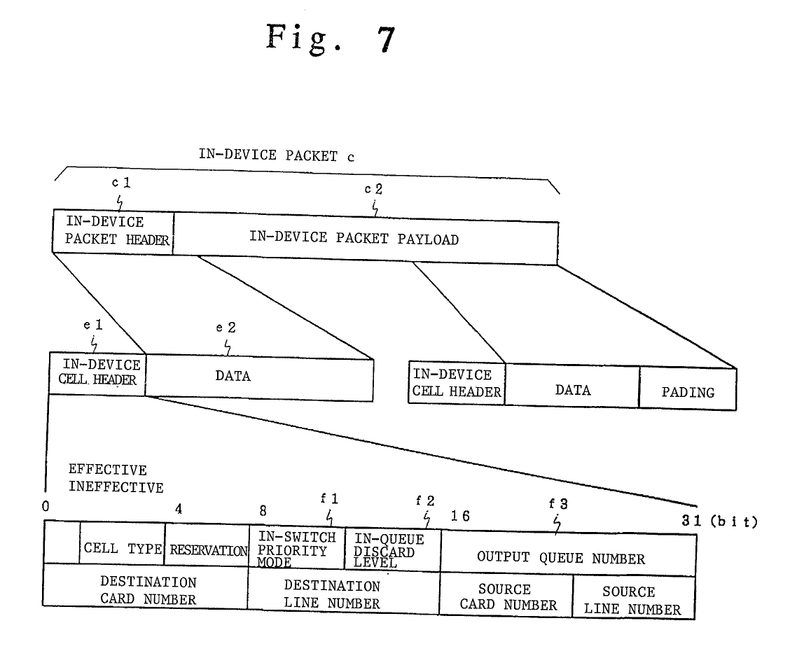

FIG. 7 shows an exemplary configuration of an in-device packet for use in the example of the present invention. In FIG. 7, in-device packet c includes in-device packet header c1 and in-device packet payload c2. In-device cell e includes in-device cell header e1 and data e2.

In-device cell header e1 has effective/ineffective, cell type, reservation, in-switch priority mode f1, in-queue discard level f2, output queue number f3, destination card number, destination line number, source card number, and source line number, stored therein.

As shown in FIG. 6, in-device packet controller 4 adds in-device packet protocol type d1 and in-device packet byte length d2 as in-device packet header c1 to IP packet b to assemble in-device packet c.

As shown in FIG. 7, in-device packet controller 4 partitions in-device packet c to in-device cells e in 72 bytes, and adds, to in-device cell e, in-device cell header e1 (8 bytes) including in-switch priority mode (f1) 200, in-queue discard level (f2) 201, output queue number (f3) 205 and the like to create in-device cell e which is sent to input side in-device cell buffer 5.

Input side in-device cell buffer 5 (16 ports) transmits in-device cell header e1 to input side bandwidth controller 7. Input side bandwidth controller 7 (16 ports) processes the header information for each port with RR (Round Robin).

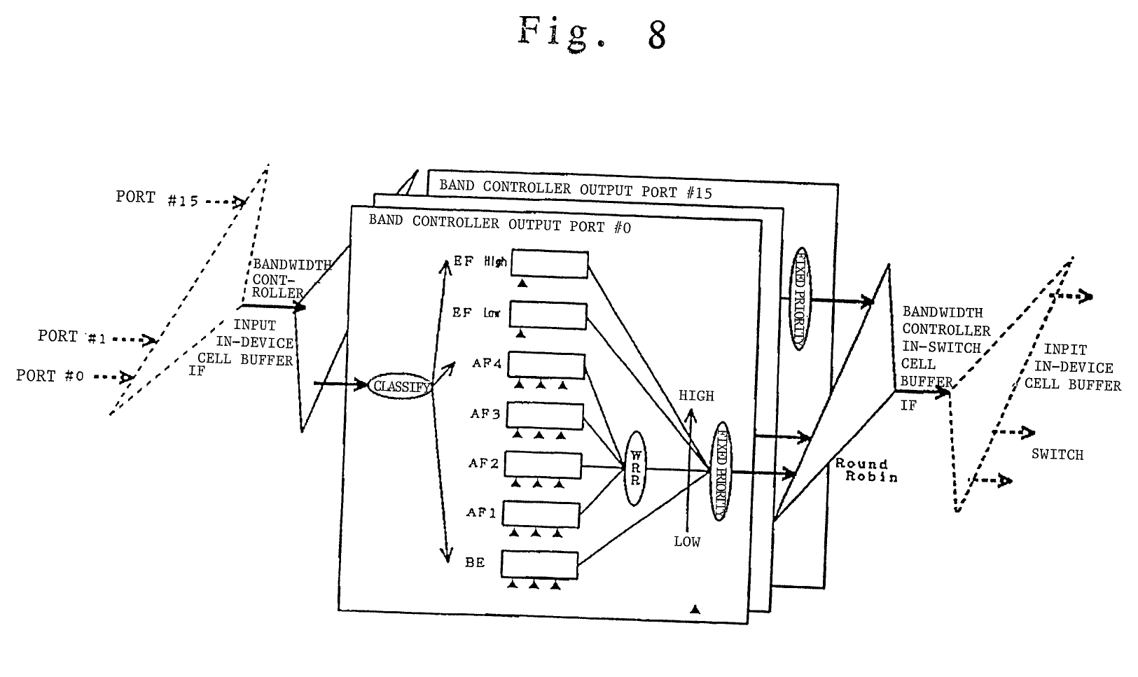

FIG. 8 shows processing operations at ports #0 to #15 of input side bandwidth controller 7 in FIG. 2. FIG. 9 shows classification based on the value of in-switch priority mode 200 in FIG. 2.

As shown in FIG. 8, at each port of input side bandwidth controller 7, the value of in-switch priority mode 200 of in-device cell header e1 is referred to for classification with DiffServ (Differentiated Services) defined in RFC2475, RFC2597, and RFC2598, that is, classification into an EF (Expedited Forwarding) High class, an EF Low class, AF (Assured Forwarding) 1 to 4 classes, and a BE (Best Effort) class, followed by insertion into each queue.

At each port of input side bandwidth controller 7, scheduling is performed by using WRR (Weighted Round Robin) for queues of AF 1 to 4.

At each port of input side bandwidth controller 7, scheduling is performed with fixed priority in the order of the EF High, EF Low, WRR outputs of the AF 1 to 4 class, and the BE class, and then outputs from the respective ports are scheduled with RR. Input side bandwidth controller 7 instructs input side in-device cell buffer 5 to output in-device cell e including scheduled in-device cell header e1 to switch 9.

In FIG. 9, the value “XX00” of in-switch priority mode 200 represents a priority mode of “highest priority”, the class of output side in-device cell buffer 6 of “EF High”, the class of input side in-device cell buffer 5 of “EF”, and “with delay assurance and with bandwidth assurance.”

The value “XX01” of in-switch priority mode 200 represents a priority mode of “the second highest priority”, the class of output side in-device cell buffer 6 of “EF Low”, the class of input side in-device cell buffer 5 of “EF”, and “with delay assurance and with bandwidth assurance”.

The value “0010” of in-switch priority mode 200 represents a priority mode of “the third highest priority”, the class of output side in-device cell buffer 6 of “AF1”, the class of input side in-device cell buffer 5 of “AF1”, and “without delay assurance and with bandwidth assurance”.

The value “0110” of in-switch priority mode 200 represents the priority mode of “the third highest priority”, the class of output side in-device cell buffer 6 of “AF2”, the class of input side in-device cell buffer 5 of “AF2”, and “without delay assurance and with bandwidth assurance”.

The value “1010” of in-switch priority mode 200 represents a priority mode of “the third highest priority”, the class of output side in-device cell buffer 6 of “AF3”, the class of input side in-device cell buffer 5 of “AF3” and “without delay assurance and with bandwidth assurance”.

The value “1110” of in-switch priority mode 200 represents a priority mode of “the third highest priority”, the class of output side in-device cell buffer 6 of “AF4”, the class of input side in-device cell buffer 5 of “AF4”, and “without delay assurance and with bandwidth assurance”.

The value “XX11” of in-switch priority mode 200 represents a priority mode of “the least highest priority”, the class of output side in-device cell buffer 6 of “BE”, the class of input side in-device cell buffer 5 of “BE”, and “without delay assurance and without bandwidth assurance”.

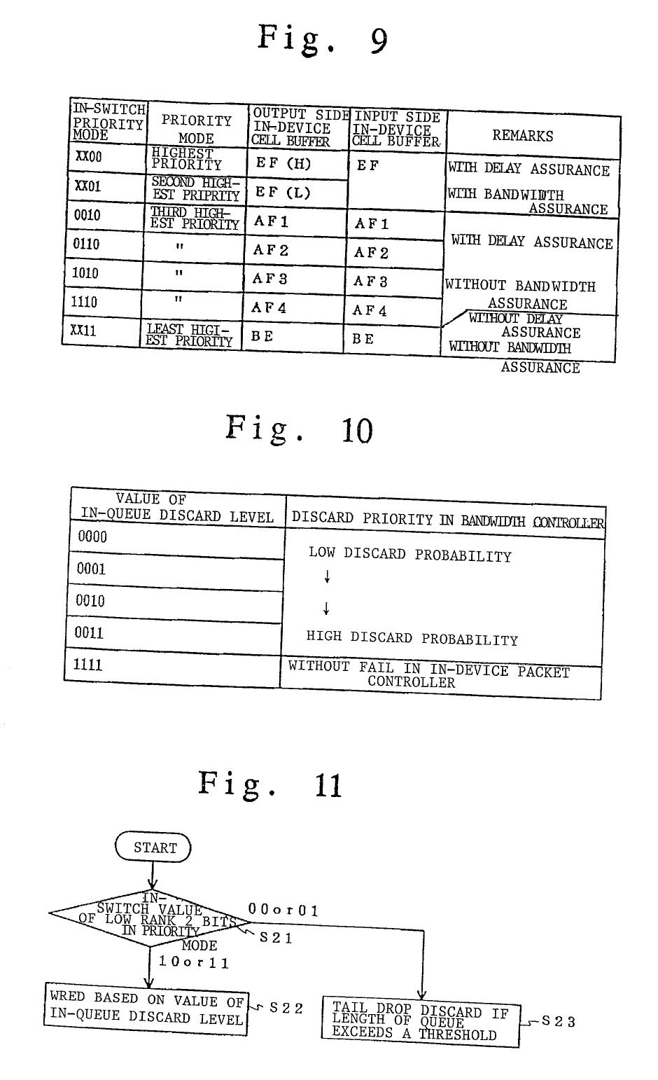

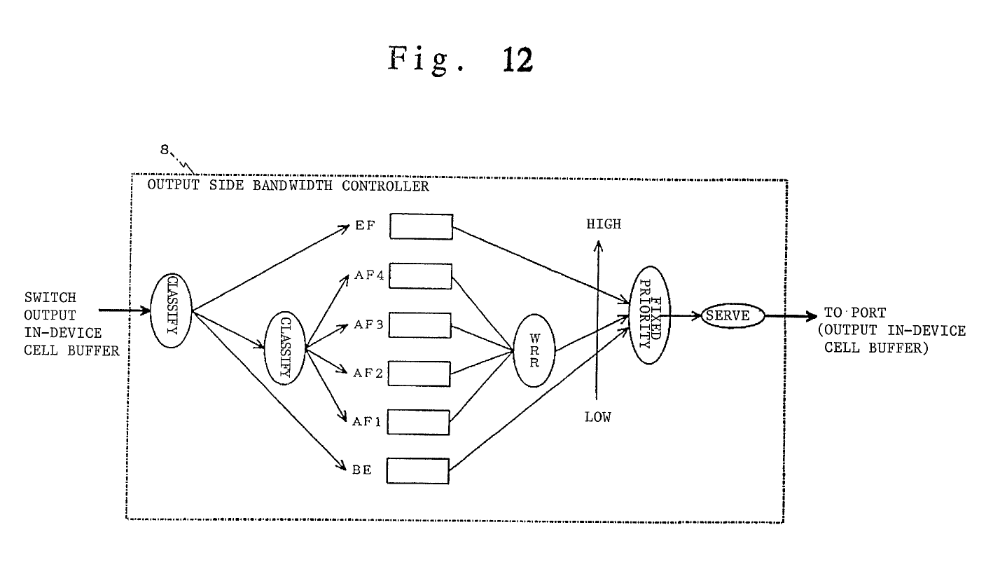

FIG. 10 shows discard priorities based on the value of in-queue discard level 201 in FIG. 2. FIG. 11 is a flow chart illustrating processing operations of input side bandwidth controller 7 in FIG. 2. Description is made for the processing operations of input side bandwidth controller 7 with reference to FIGS. 2, 10, and Input side bandwidth controller 7 performs, for in-device cell e having the value of in-switch priority mode 200 of “10” or “11” (step S21 in FIG. 11), WRED (Weighted Random Early Detection) based on the value of in-queue discard level 201 (step S22 in FIG. 11).

In FIG. 11, the probability of discard is higher in the order of “0000”, “0001”, “0010”, and then “0011” of the values of in-queue discard level 201. When the value of in-queue discard level 201 is “1111”, it is discarded without fail in in-device packet controller 4.

Details on the WRED are described in “Random Early Detection gateways for Congestion Avoidance” (Floyd,S., and Jacobson,V., IEEE/ACM Transactionson Networking, V.1 N.4, August 1993, pp.397-413).

On the other hand, for in-device cell e having the value of in-switch priority mode 200 of “00” or “01” (step S21 in FIG. 11), input side bandwidth controller 7 performs tail drop discard if the length of the queue exceeds a threshold value, regardless of the value of in-queue discard level 201 (step S23 in FIG. 11).

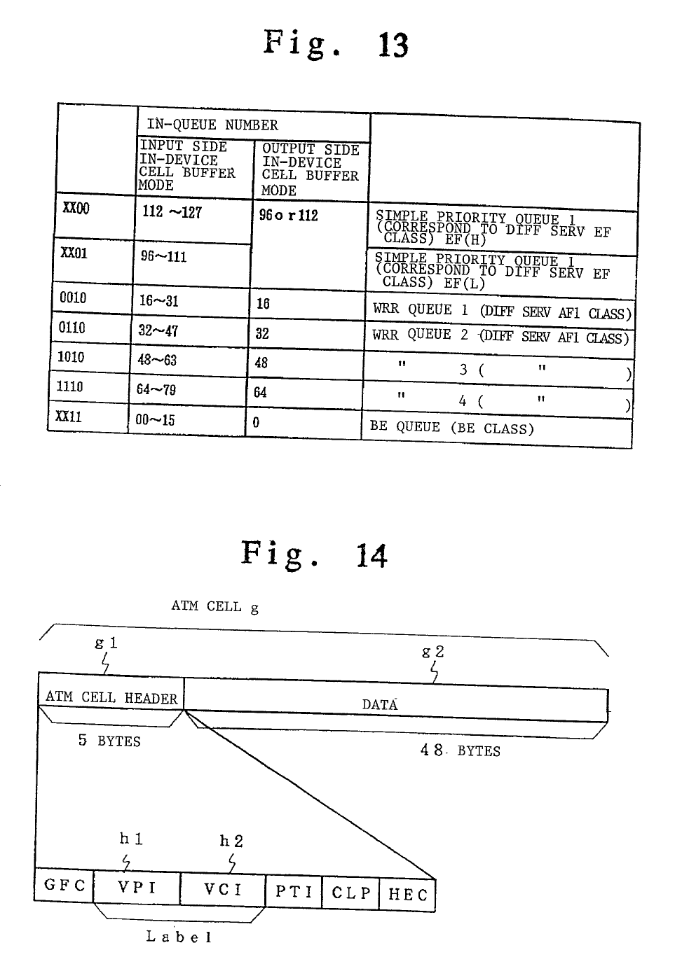

FIG. 12 illustrates processing operations in output side in-device cell buffer 6 in FIG. 2. FIG. 13 is a table for illustrating determination of which queue is used on the basis of the value of in-switch priority mode 200 in FIG. 2.

Input in-device cell buffer 5 transmits in-device cell e to switch 9 in accordance with the processing of input side bandwidth controller 7. Switch 9 performs switching of in-device cell e and outputs it to output side in-device cell buffer 6. output side in-device cell buffer 6 transmits in-device cell buffer e1 to output side bandwidth controller 8. Output side bandwidth controller 8 determines which queue to be used on the basis of the value of in-switch priority mode 200 in in-device cell header e1.

A simple priority queue (corresponding to the DiffServ EF class) is used for the value of in-switch priority mode 200 of “XX00”, WRR queue 1 (corresponding to the DiffServ AF1 class) is used for “0010”, WRR queue 2 (corresponding to the DiffServ AF2 class) is used for “0110”, WRR queue 3 (corresponding to the DiffServ AF3 class) is used for “1010”, WRR queue 4 (corresponding to the DiffServ AF4 class) is used for “1110”, and a BE queue (corresponding to the BE class) is used for “XX11” (see FIG. 13).

Output side bandwidth controller 8 performs scheduling with fixed priority in the order of the EF, AF 1 to 4, and BE classes, with the use of the WRR for the AF1 to 4 classes. Output side bandwidth controller 8 instructs output side in-device cell buffer 6 to output in-device cell e including scheduled in-device cell header e1 to in-device packet controller 4 (see FIGS. 1, 2).

In accordance with the processing of output side bandwidth controller 8, output in-device cell buffer 6 transmits in-device cell e to in-device packet controller 4. In-device packet controller 4 assembles in-device packet c from in-device cell e and removes in-device packet header c1 from in-device packet c to obtain IP packet b.

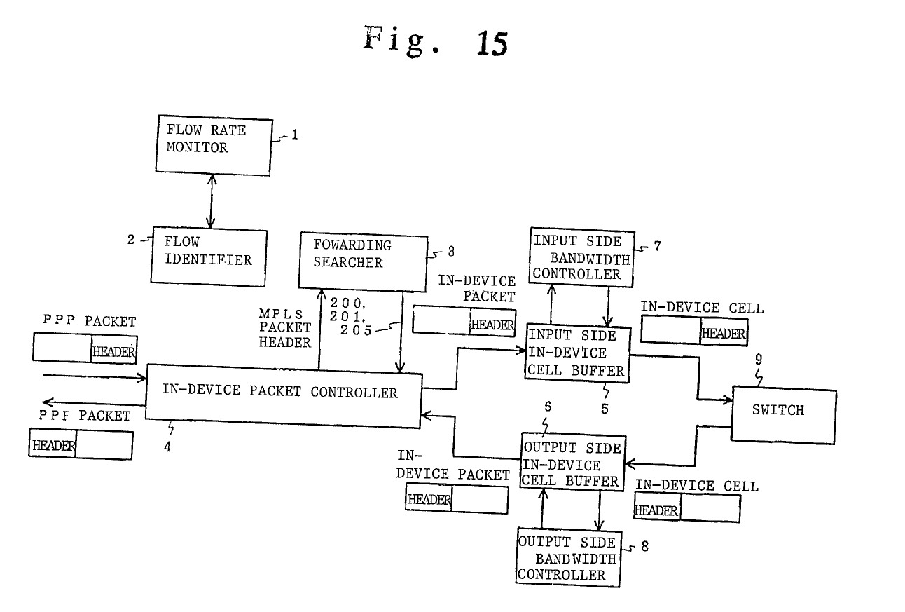

FIG. 14 shows an exemplary configuration of an ATM cell for use in the example of the present invention. In FIG. 14, ATM cell g includes ATM cell header g1 (5 bytes) and data g2 (48 bytes).

ATM cell header g1 has a GFC (Generic Flow Control), VPI (Virtual Path Identifier) h1, VCI (Virtual Circuit Identifier) h2, a PTI (Payload Type Identifier), a CLP (Cell Loss Priority), and an HEC (Header Error Control), stored therein. The VPI and VCI constitute Label.

When an output line is for ATM cell g, output queue number 205 is converted into VPI h1 and VCI h2 in ATM cell header g1 which are added to ATM cell header g1 after segmentation.

Alternatively, when the output line is a common medium line such as Ethernet, output queue number 205 is converted into Next Hop information, and a corresponding MAC (Media Access Control) address is added as a DA of an Ethernet frame. For PPP packet a, PPP packet header a1 is added. In-device packet controller 4 transmits a frame created as described above.

In this manner, in-switch priority mode 200, in-queue discard level 201, and output queue number 205 are used as in-device cell header e1 to allow prioritized transmission of packets of high priority such as telephone services as lifelines for urgent notification or electronic exchange/stock exchange.

It is thus possible to flexibly set QoS (Quality of Services) required for each of various services without recognizing a change in a ratio between communication services and to realize a reliable network with economy equal to current IP networks.

Output queue number 205 is used not only for priority control but also for representing an output virtual line or Next Hop information, thereby making it possible to handle equally the in-device cell format in any of cases where the output line is for ATM, Ethernet, and PPP.

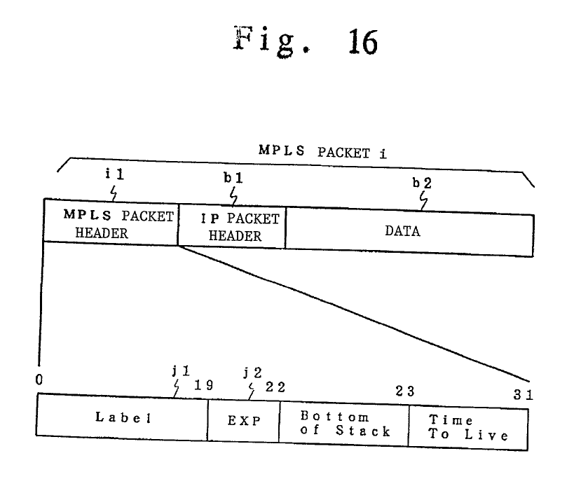

FIG. 15 is a block diagram showing a configuration of a router device according to another example of the present invention. In FIG. 15, the router device of the other example of the present invention comprises flow rate monitor 1, flow identifier 2, forwarding searcher 3, in-device packet controller 4, input side in-device cell buffer 5, output side in-device cell buffer 6, input side bandwidth controller 7, output side bandwidth controller 8, and switch 9. FIG. 15 shows an exemplary configuration for MPLS (Multiprotocol Label Switching) label search on a PPP line.

FIG. 16 shows a configuration of an MPLS packet for use in the other example of the present invention. In FIG. 16, MPLS packet i includes MPLS packet header i1 and IP packet b including IP packet header b1 and data b2. MPLS packet header i1 has Label j1, EXP bit j2, Bottom of Stack, and Time To Live, stored therein.

In-device packet controller 4 removes PPP packet header al in PPP packet a input thereto, and passes MPLS packet header i1 to forwarding searcher 3 if it is MPLS packet i.

Forwarding searcher 3 searches MPLS packet header i1 for Label j1, and outputs the value of in-switch priority mode 200 to in-device packet controller 4.

The value of in-switch priority mode 200 is a value obtained as the search result of Label j1 in MPLS packet header i1 in the case of L-LSP (Label-inferred per hop behavior scheduling class Label Switched Paths).

In the case of E-LSP (EXP-inferred per hop behavior scheduling class Label Switched Paths), forwarding searcher 3 sees EXP bit j2 in MPLS packet header i1 and outputs the value of in-switch priority mode 200 to in-device packet controller 4.

Flow identifier 2 sees EXP bit j2 in MPLS packet header i1 and outputs in-queue discard level 201 to in-device packet controller 4. Flow identifier 2 outputs, as output queue number 205, a value obtained as a search result of Label j1 in MPLS packet header i1 to in-device packet controller 4. Output queue number 205 may also be used as a logical line number (VPI/VCI for ATM, for example) of an output line or Next Hop information (for a common medium line such as Ethernet).

In addition, it is extremely easy to extend priority control, later described, by using output queue number 205 to select a queue in output side in-device cell buffer 6, for example.

In-device packet controller 4 adds in-device packet protocol type d1 and in-device packet byte length d2 in in-device packet c as in-device packet header c1 to MPLS packet i to assemble in-device packet c. In-device packet controller 4 partitions in-device packet c to in-device cell e in 72 bytes, adds, to in-device cell e, in-device cell header e1 (8 bytes) including in-switch priority mode 200, in-queue discard level 201, output queue number 205 and the like to create in-device cell e which is sent to input side in-device cell buffer 5.

Input side in-device cell buffer 5 (16 ports) transmits in-device cell header e1 to input side bandwidth controller 7. Input side bandwidth controller 7 (16 ports) processes the header information for each port with RR. At each port of input side bandwidth controller 7, the value of in-switch priority mode 200 in in-device cell header e1 is referred to for classification into an EF High class, an EF Low class, AF1 to 4 classes, and a BE class, followed by insertion into each queue.

Scheduling is performed by using WRR for queues of AF 1 to 4. Input side bandwidth controller 7 performs scheduling with fixed priority in the order of the EF High, EF Low, WRR outputs of the AF 1 to 4 classes, and the BE class, and then outputs from the respective ports are scheduled with RR. Input side bandwidth controller 7 instructs input side in-device cell buffer 5 to output in-device cell e including scheduled in-device cell header e1 to switch 9.

Input side bandwidth controller 7 performs WRED based on the value of in-queue discard level 201 for a cell having the value of in-switch priority mode 200 of “10” or “11.” For a cell having the value of in-switch priority mode 200 of “00” or “01”, input side bandwidth controller 7 performs tail drop discard if the length of the queue exceeds a threshold value, regardless of the value of in-queue discard level 201.

In accordance with the processing of input side bandwidth controller 7, input in-device cell buffer 5 transmits in-device cell e to switch 9. Switch 9 performs switching of in-device cell e and outputs it to output side in-device cell buffer 6.

Output side in-device cell buffer 6 transmits in-device cell header e1 to output side bandwidth controller 8. Output side bandwidth controller 8 determines which queue to be used on the based of the value of in-switch priority mode 200 in in-device cell header e1.

A simple priority queue (corresponding to the DiffServ EF class) is used for the value of in-switch priority mode 200 of “XX00”, WRR queue 1 (corresponding to the DiffServ AF1 class) is used for “0010”, WRR queue 2 (corresponding to the DiffServ AF2 class) is used for “0110”, WRR queue 3 (corresponding to the DiffServ AF3 class) is used for “1010”, WRR queue 4 (corresponding to the DiffServ AF4 class) is used for “1110”, and a BE queue (corresponding to the BE class) is used for “XX11”.

Output side bandwidth controller 8 performs scheduling with fixed priority in the order of the EF, AF 1 to 4, and BE classes, with the use of the WRR for the AF1 to 4 classes. Output side bandwidth controller 8 instructs output side in-device cell buffer 6 to output in-device cell e including scheduled in-device cell header e1 to in-device packet controller 4.

In accordance with the processing of output side bandwidth controller 8, output in-device cell buffer 6 transmits in-device cell e to in-device packet controller 4. In-device packet controller 4 assembles in-device packet c from in-device cell e and removes in-device packet header c1 from in-device packet c to obtain MPLS packet i.

When an output line is for ATM, output queue number 205 is converted into VPI h1 and VCI h2 in ATM cell header g1 which are added to ATM cell header g1 after segmentation.

Alternatively, when the output line is a common medium line such as Ethernet, output queue number 205 is converted into Next Hop information, and a corresponding MAC address is added as a DA of an Ethernet frame. For PPP packet a, PPP packet header al is added. In-device packet controller 4 transmits a frame created as described above.

In this manner, since the MPLS label search can realize connection oriented services on an IP network, not shown, in addition to features provided in the description of the example of the present invention, it is possible to provide functions such as Traffic Engineering.

What is claimed is:

1. A router device adding unique header information to a packet within said device in processing said packet, said router device comprising:
packet control means for adding said header information to said packet, said header information including at least an in-device priority mode for representing priority in said device, an in-device discard level for representing a probability of discard in said device, and a queue number for performing bandwidth control,
wherein said header information is used to perform priority control.

2. The router device according to claim 1, wherein said in-device priority and said in-device discard level are used in said device to realize differentiated services and a value of said output queue number is designated.

3. The router device according to claim 2, wherein said packet control means converts a packet input thereto into an in-device cell in a form in said device, and adds said header information to said in-device cell.

4. The router device according to claim 1, further comprising:
flow identifying means for detecting a flow which is a set of packets having a certain property from packets input to said device;
flow rate monitoring means for detecting whether a previously determined bandwidth under control is violated for each said flow; and
forwarding searching means for determining, from contents of said packet, output line information indicating from which line said packet is to be output,
wherein said packet control means creates and adds said header information based on flow information detected by said flow identifying means, information detected by said flow rate monitoring means, and output line information determined by said forwarding searching means.

5. The router device according to claim 4, wherein said flow rate monitoring means detects whether actual traffic matches, temporarily violates, or completely violates the previously determined bandwidth under contract for each said flow.

6. The router device according to claim 1, further comprising:
an input side in-device cell buffer for temporarily storing said in-device cell;
an output side in-device cell buffer provided corresponding to an output line for temporarily storing said in-device cell; and
switching means for switching said in-device cell stored in said input side in-device cell buffer to said output side in-device cell buffer,
wherein said input side in-device cell buffer, said output side in-device cell buffer, and said switching means are controlled on the basis of said header information.

7. A method of controlling priority for a router device adding unique header information to a packet within said device in processing said packet, said method comprising the steps of:
adding said header information to said packet, said header information including at least an in-device priority mode for representing priority in said device, an in-device discard level for representing a probability of discard in said device, and a queue number for performing bandwidth control; and
using said header information to perform priority control.

8. The method of controlling priority according to claim 7, wherein said in-device priority and said in-device discard level are used to realize differentiated services and a value of said output queue number is designated.

9. The method of controlling priority according to claim 8, wherein an input packet is converted into an in-device cell in a form in said device, and said header information is added to said in-device cell.

10. The method of controlling priority according to claim 7, wherein said header information is created and added on the basis of information obtained by using the steps of: detecting a flow which is a set of packets having a certain property from packets input to said device, detecting whether a previously determined bandwidth under control is violated for each said flow, and determining, from contents of said packet, output line information indicating from which line said packet is to be output.

11. The method of controlling priority according to claim 10, wherein the step of detecting whether a previously determined bandwidth under control is violated for each said flow detects whether actual traffic matches, temporarily violates, or completely violates the previously determined bandwidth under contract for each said flow.

12. The method of controlling priority according to claim 7, wherein the step of using said header information to perform priority control, further comprising the steps of:
temporarily storing said in-device cell to an input side in-device cell buffer;
temporarily storing said in-device cell to an output side in-device cell buffer provided corresponding to an output line; and
switching said in-device cell stored in said input side in-device cell buffer to said output side in-device cell buffer.
